(19) United States
(12) Patent Application Publication
(10) Pub. No.: US 2025/0085701 A1
(43) Pub. Date: Mar. 13, 2025

(54) Granular Display of a Loading State of Web-Based Elements of a Control System for a Technical Plant

(71) Applicant: Siemens Aktiengesellschaft, Muenchen (DE)

(72) Inventors: Benjamin LUTZ, Pfinztal (DE); Georg KLUGE, Linkenheim (DE)

(21) Appl. No.: 18/580,656

(22) PCT Filed: Jul. 18, 2022
(86) PCT No.: PCT/EP2022/070056

§ 371 Date: Jan. 19, 2024

(30) Foreign Application Priority Data
Jul. 21, 2021 (EP) 21187067

(51) Int. Cl. G05B 19/418

(52) U.S. Cl. CPC G05B 19/41885; G05B 19/4184; G05B 19/41845; G05B 19/4185; G05B 2219/13144

(57) ABSTRACT

A control system for a technical plant, particularly a process or manufacturing plant, includes an operator station server and an operator station client, wherein the operator station server transmits, for operation and monitoring, an image of the technical plant to the operator station client, the operator station client visually displays the image with a plurality of image elements to an operator of the technical plant and the control system includes a visualization service implemented on the operator station server for a first part and implemented on the operator station client for a second part, where the visualization service is configured to determine information about an accumulated transmission status of the plurality of image elements from the operation station server to the operator station client and to visually display them to the operator of the control system, and where the accumulated transmission status is a logical Boolean value.

### CROSS-REFERENCE TO RELATED APPLICATIONS

This is a U.S. national stage of application No. PCT/EP2022/070056 filed 18 Jul. 2022. Priority is claimed on European Application No. 21187067.0 filed 21 Jul. 2021, the content of which is incorporated herein by reference in its entirety.

### BACKGROUND OF THE INVENTION

### 1. Field of the Invention

The invention relates to the use of a control system, a method for visually displaying a mimic diagram of a technical plant and to a control system for a technical plant, in particular a process or manufacturing plant, having an operator station server and an operator station client, where the operator station server is configured to transmit, for operation and observation, a mimic diagram of the technical plant to the operator station client, where the plant mimic diagram comprises a plurality of diagram elements, where the operator station client is embodied to visually display the plant mimic diagram with the plurality of diagram elements to an operator of the technical plant, and where the control system has a visualization service, which is implemented on the operator station server for a first part and on the operator station client for a second part.

### 2. Description of the Related Art

For operating and observing process engineering plants, process engineering plant control systems create symbolic plant mimic diagrams representing process engineering relationships, particularly between individual process objects of the process engineering plants, in an abstract manner.

Plant mimic diagrams are composed of static symbols (for example, lines, and/or rectangles), dynamic symbols (for example, lines with color changes or rectangles with fill levels that change in dependence on process measurement values), block symbols (for dynamic visualization of process engineering objects), complex controls (for example, trend indicators, and/or message sequence indicators) and containers in which content from independent and autonomous sources can be visualized. These sources can, for example, be webcams, mimic diagrams of modular plant parts (“package units”), apps (for example, regulator optimizers, KPI calculations) and the like.

Containers are realized with different technologies. In modern web-oriented control systems, “iframes” can be used for this purpose, such as in the SWAC technology used by Siemens (here, SWAC stands for “Siemens “Web Application Collaboration”).

The aforementioned complex controls (trend indicators, XY graphs, message sequence indicators, SFC step chains, CFC visualization, and/or batch) can also be embedded in plant mimic diagrams with the aid of containers because this enables the underlying applications to be decoupled and distributed at the server side in order to achieve a higher degree of robustness.

Hence, modern plant mimic diagrams are heterogeneous, because these plant mimic diagrams are not dynamized by one single application (for example, plant display), but by many different applications, which can also be localized on different servers (e.g., alarm control, trend control, and/or webcam control). This modularity is useful and necessary for addressing Industry 4.0 requirements (especially with regard to flexible, modular and dynamically reconfigurable plants), but presents corresponding challenges for the visualization of heterogeneous plant mimic diagrams in operator station clients, particularly with respect to stability, reliability and performance of operator station clients.

In addition to dynamization, another challenge to be faced with plant mimic diagrams designed in this way is so-called diagram opening. Even if the plant mimic diagram appears to be opened for the operator and block symbols are dynamized, this does not necessarily mean that the complex controls that it contains are already fully or even partially loaded. If, for example, a message sequence indicator with a complex query (archived diagnostic data for entire plant parts) is used in a plant mimic diagram, then it can take several seconds for the necessary content to be read from the archives and displayed.

In the period immediately after the plant mimic diagram is activated, the content of the projected message sequence indicator remains “white” and operators could incorrectly assume that there are no diagnostic messages and change to the next plant mimic diagram in the course of their observations. Hence, there is a risk that (incorrect) decisions will be made based on incompletely loaded plant mimic diagrams, in particular because there is no known solution or approach for ascertaining the loading state of a heterogeneous plant mimic diagram and making the operator aware of this.

Known control systems are, for example, disclosed in WO 2020/064712 A1 and EP 3680740 A1.

### SUMMARY OF THE INVENTION

It is an object of the invention to provide a control system for a technical plant which can notify an operator of the control system of a loading state and thus the reliability of a plant mimic diagram displayed by the control system.

This and other objects and advantages are achieved in accordance with the invention by a control system for a technical plant, in particular a manufacturing or process plant, by the use of a control system for operating the technical plant, and by a method for visually displaying a mimic diagram of the technical plant.

The control system in accordance with the invention includes a visualization service that is configured to ascertain information about an accumulated transmission status of the plurality of diagram elements from the operator station server to the operator station client and to display this visually to the operator of the control system, where the accumulated transmission status represents a logical Boolean value.

In the present context, a control system should be understood to be a computer-aided technical system comprising functionalities for displaying, operating and controlling a technical system, such as a manufacturing or production plant. In addition to the operator station server and the operator station client, the control system can, for example, also comprise process-related or manufacturing-related components that are used to actuate actuators or sensors.

The technical plant can be a plant from the process industries, such as a chemical, pharmaceutical, petrochemical plant or a plant from the food and beverage industries. This also includes all plants from production industries, factories in which, for example, cars or goods of all types are produced. Technical plants suitable for performing the method in accordance with the invention can also come from the field of power generation. Wind turbines, solar farms or power plants for power generation are likewise covered by the term technical plant.

In the present case, an “operator station server” should be understood to be a server that centrally acquires data from an operator control and observation system and generally alarm and measured value archives from a control system of a technical plant and makes this data available to users. The operator station server generally establishes a communication link to automation systems (such as an automation device) of the technical plant and forwards data on the technical plant to “operator station clients” that are used to control and observe the operation of the individual functional elements of the technical plant.

The operator station server itself can have client functions in order to access the data (archives, messages, tags, variables) of other operator station servers. This means that diagrams of the operation of the technical plant can be combined on the operator station server with variables of other operator station servers (server-server communication). The operator station server can, without being restricted thereto, be a SIMATIC PCS 7 Industrial Workstation server from SIEMENS.

The plant mimic diagram that the operator station server transmits to the operator station client for visual display is an operator diagram usually used for control systems comprising graphical representations of individual elements of the technical plant that is used to display the status of the individual elements, of a (for example, process engineering) relationship between the elements or the like. The individual elements of the technical plant are graphically represented in the plant mimic diagram by respective diagram elements. Here, the plant mimic diagram comprises at least one diagram element.

The visualization service is implemented on the operator station server for a (first) part and on the operator station client for a (second) part. The first part on the operator station server compiles or provides the data required for the plant mimic diagram and transmits the visualization data to the operator station client. There, the second part of the visualization service has the task of generating a visual display of the plant mimic diagram with the at least one diagram element for a monitor, a smartphone, a tablet or the like.

Herein, in accordance with the invention, the visualization service is configured to ascertain information about a transmission status of the plurality of diagram elements from the operator station server to the operator station client and to display this visually to the operator of the control system. To ascertain the transmission status, the first part of the visualization service advantageously knows the amount of data that it has to transmit to the operator station client with respect to the diagram elements. The visualization service can determine the transmission status of the diagram elements via a corresponding item or items of feedback from the second part of the visualization service and transfer it to the operator station client. This can then visually display the accumulated transmission status of diagram elements to an operator of the control system.

The control system in accordance with the invention enables an indication of the accumulated loading state of the diagram elements for more efficient operation and observation of the technical plant. The operator is informed by the control system about when the opened plant mimic diagram with the plurality of diagram elements can be fully observed.

The respective diagram element can have content that can be changed during runtime of the technical plant, in particular a trend indicator for measured values of the technical plant, a message sequence indicator for messages from the control system, a video image or a regulator optimization function. Herein, the respective diagram element can be a so-called (web) container that can be variably filled with dynamically changeable content.

The plant mimic diagram comprises a plurality of diagram elements, where the visualization service is configured to ascertain information about an accumulated transmission status of the plurality of diagram elements from the operator station server to the operator station client and display this visually to the operator of the control system.

Herein, the visualization service is configured to ascertain information about an accumulated transmission status of the diagram elements from the operator station server to the operator station client and to display this visually to the operator of the control system.

The accumulated transmission status represents a logical Boolean value. Herein, this can entail the two logical Boolean values “FALSE” and “TRUE”. Herein, the transmission status has the logical value “FALSE” until the transmission of the respective diagram element from the operator station server to the operator station client is fully complete.

The accumulated transmission status can represent a number of transmission statuses with a specific logical Boolean value, in particular the logical Boolean value FALSE. The operator then obtains an immediate overview of how many diagram elements of a plant mimic diagram have not yet been fully transmitted to the operator station client.

Particularly preferably, the transmission status of a diagram element can be influenced by interaction between the operator and the diagram element. This can, for example, mean that an operator operating a diagram element in which an archive for messages from the technical plant is addressed triggers reloading (or retransmission) of the content of the diagram element. This can be due to the fact that only some of the messages in the archive are transmitted to the operator station client by default to keep the communication volume and the memory load on the operator station client low.

Here, the operator's action can then lead to a change in the transmission status of the diagram element, for example from “TRUE” to “FALSE”.

The transmission status can be displayed to the operator in various ways. The visualization service can be configured to visually display the transmission status of a respective diagram element to the operator by varying a display intensity of the respective diagram element. Accordingly, the respective diagram element can, for example, be “grayed out” to intuitively indicate to the operator that the diagram element has not yet been fully loaded. Herein, the display intensity can change in discrete steps (for example, for logical Boolean values).

The visualization service can furthermore be configured to visually display the transmission status of a respective diagram element to the operator by varying a display color of the diagram element. These embodiments enable particularly intuitive and rapid acquisition of the transmission status of the diagram elements of a plant mimic diagram.

In the context of an advantageous embodiment of the invention, the control system is configured to store information in a memory about a period of time over which a diagram element of a plant mimic diagram has had which transmission status. This information, in particular when a transmission of a diagram element began and when it ended, can be used to draw conclusions about which plant mimic diagram was possibly “overloaded” when planning automation for the technical plant. It is also possible to ascertain which diagram element or which diagram elements of a plant mimic diagram are responsible for long transmission times and therefore may possibly need to be revised.

This enables plant mimic diagrams to be specifically optimized with regard to display quality and display currency.

The objects and advantages are also achieved in accordance with the invention by the use of a control system configured as explained above to operate a technical plant, in particular a process or manufacturing plant.

The objects and advantages are also achieved in accordance with the invention by a method for visually displaying a mimic diagram of a technical plant, in particular a process or manufacturing plant, by a control system having an operator station server and an operator station client, where the plant mimic diagram comprises a plurality of diagram elements, and where the method comprises:
a) transmitting the mimic diagram of the technical plant from the operator station server to the operator station client, wherein the plant mimic diagram comprises the plurality of diagram elements;
b) ascertaining information about an accumulated transmission status of the plurality of diagram elements from the operator station server to the operator station client during transmission of the plant mimic diagram with the plurality of diagram elements;
c) visually displaying the plant mimic diagram with the plurality of diagram elements to an operator of the control system by the operator station client;
d) visually displaying the information about the accumulated transmission status of the diagram element from the operator station server to the operator station client together with the visual display of the plant mimic diagram with the plurality of diagram elements, wherein the accumulated transmission status represents a logical Boolean value.

The information about the accumulated transmission status of the diagram element can be ascertained by a visualization service, where a first part of the visualization service is implemented on the operator station server and a second part of the visualization service is implemented on the operator station client.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which they are achieved will become clearer and more plainly comprehensible in conjunction with the following description of an exemplary embodiment explained in more detail in conjunction with the drawings, in which:

FIG. 1 is a schematic illustration of a control system in accordance with the invention;

FIG. 2 is an object model of a control system in accordance with the invention;

FIG. 3 is a first visual display of a plant mimic diagram by a control system in accordance with the invention;

FIG. 4 is a second visual display of a plant mimic diagram by a control system in accordance with the invention; and

FIG. 5 is a flowchart of the method in accordance with the invention.

### DETAILED DESCRIPTION OF THE EXEMPLARY EMBODIMENTS

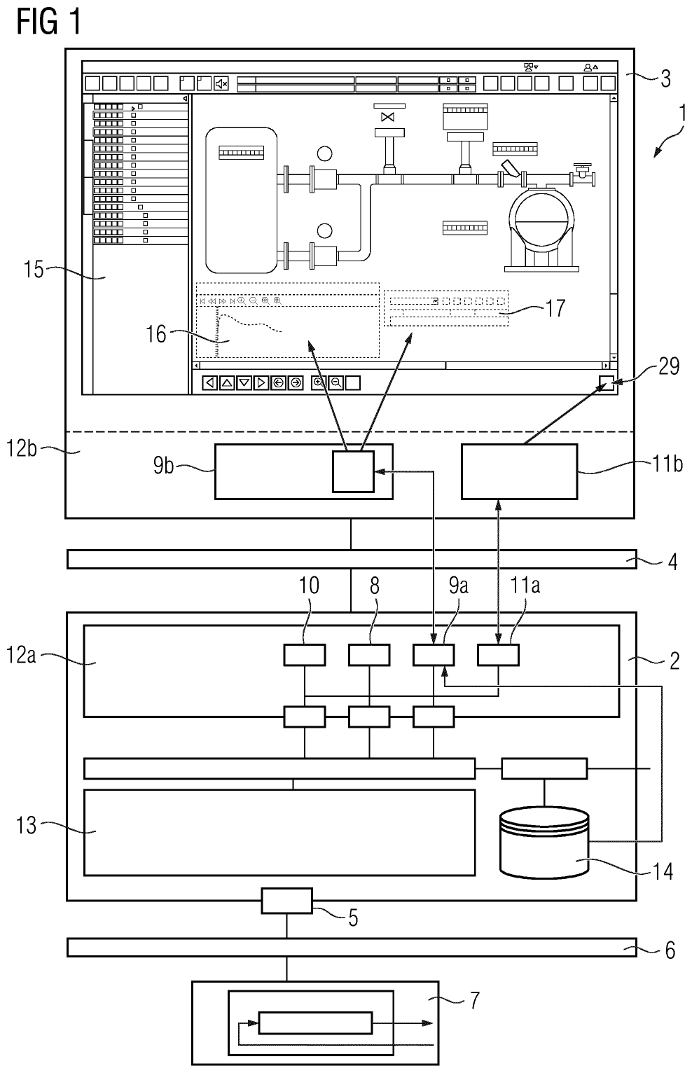

FIG. 1 depicts part of a control system 1 in accordance with the invention of a technical plant configured as a process plant, i.e., as a process engineering plant. The control system 1 comprises an operator station server 2 and an operator station client 3.

The operator station server 2 and the operator station client 3 are connected to one another via a terminal bus 4 and optionally to further components of the control system 1 (not depicted), such as a process data archive.

For the purposes of operating and observation, a user or operator can access the operator station server 2 via the operator station client 3 over the terminal bus 4. The terminal bus 4 can, without being restricted thereto, be formed as an Industrial Ethernet, for example.

The operator station server 2 has a device interface 5 that is connected to a plant bus 6. The operator station server 2 can communicate with an automation device 7 and with further optional components of the process plant via this device interface 5. The plant bus 6 can, without being restricted thereto, be formed as an Industrial Ethernet, for example. The automation device 7 can be connected to any number of subsystems (not depicted).

An alarm signal service 8, a first part 9a of a plant mimic diagram service, a monitoring service 10 and a first part 11a of an operator service are implemented on the operator station server 2. The alarm signal service 8, the first part 9a of the plant mimic diagram service, the monitoring service 10 and the first part 11a of the operator service represent a first part 12a of a visualization service implemented on the operator station server 2. Furthermore, (in addition to further components/services (not depicted)), a process map 13 and a configuration database 14 are implemented on the operator station server 2.

The first part of the plant mimic diagram service 9a takes a plant mimic diagram 15 to be displayed from the configuration database 14. The plant mimic diagram 15 is transmitted from the first part of the plant mimic diagram service 9a to a second part 9b of the plant mimic diagram service that is implemented on the operator station client 3. Herein, the second part 9b of the plant mimic diagram service and a second part 11b of the operator service are components of a second part 12b of the visualization service that is implemented on the operator station client 3 and provides the information required for the visual display of the plant mimic diagram 15 (including rendering information).

(In addition to other diagram elements), the plant mimic diagram 15 comprises two diagram elements 16, 17, the content of which can be specified variably and can change dynamically. For example, the diagram elements 16, 17 can be trend indicators for a process measurement value, video data or alarm signal indicators.

The visualization service 12a, 12b is configured to ascertain a transmission status of the respective diagram element 16, 17. For this purpose, the first part 12a of the visualization service waits for confirmation from the second part 12b of the visualization service that the respective diagram element 16, 17 has been transmitted. From this bidirectional communication between the operator station server 2 and the operator station client 3, the visualization service 12a, 12b ascertains the respective transmission status and transfers it to the operator station client 3 that displays it visually to an operator of the control system 1.

In FIG. 1, the two diagram elements 16, 17 are depicted with a broken line (“dashed”) that intuitively notifies the transmission status to the operator (not yet fully transmitted or “FALSE”) of the respective diagram element 16, 17.

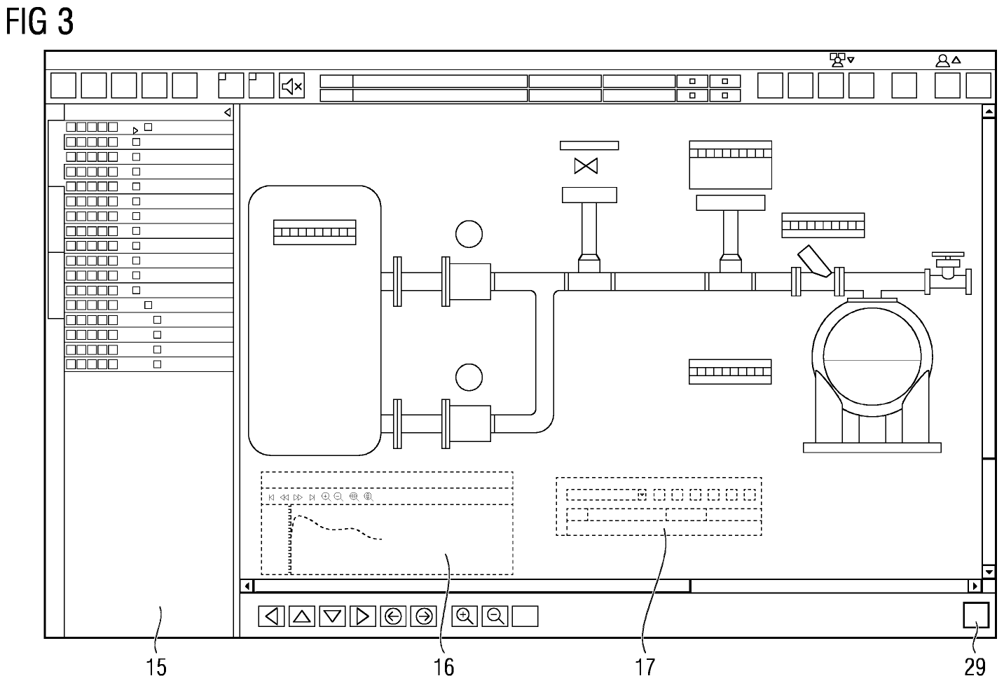

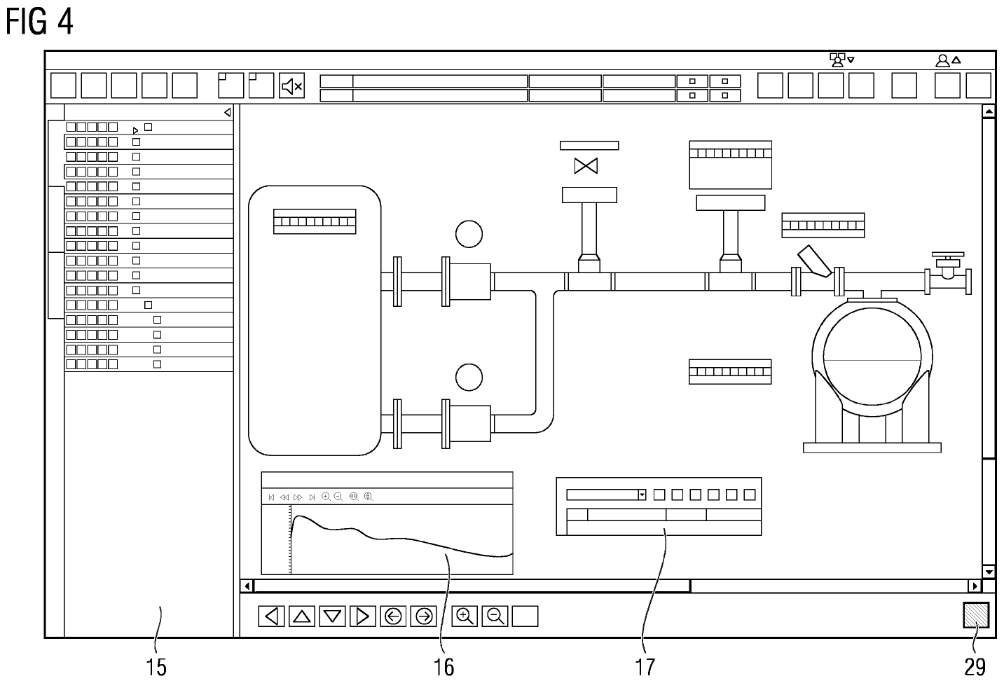

In cooperation with the monitoring service 10, the first part of the operator service 11a forms an accumulated transmission status, which in this case has the value “2”. This means that two diagram elements 16, 17 do not have the transmission status “fully transmitted” or “TRUE”. This value “2” is visually presented to the operator by the second part 11b of the operator service in a lower right-hand region of the plant mimic diagram 15 (cf. also FIG. 3 and FIG. 4).

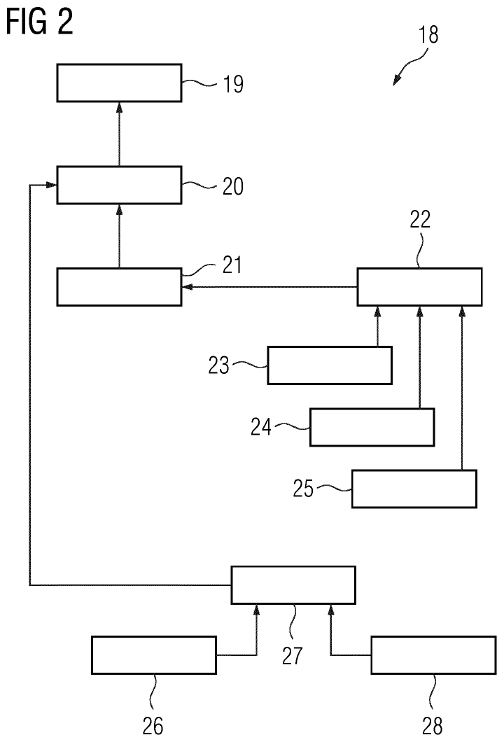

FIG. 2 depicts an object model 18 belonging to the control system 1. An automation project 19 has 1 to f plant mimic diagrams 20 (plant displays). A plant mimic diagram 20 is composed of 1 to m diagram elements 21 (screen items). One specialization of a diagram element 21 is a complex control element 22 (complex control). This complex control element 22 can in turn be a message sequence indicator 23, a trend indicator 24 or a webcam indicator 25.

The complex control element 22 has a “transmission status” attribute that indicates the transmission status of the complex control element 22 from the operator station server 2 to the operator station client 3. Upon commencement of a transmission of the plant mimic diagram 20 to the operator station client 3, the attribute has the value “FALSE”. Only when the respective specialization (message sequence indicator 23, and/or trend indicator 24) has updated and transmitted the content of the control element 22, do the specializations set the transmission status or the attribute to the value “TRUE”. This can, for example, mean that all historical diagnostic signals of the message sequence indicator 23 have been loaded into the operator station client 3 and visually displayed to the operator of the control system 1.

The transmission status can be reset to “FALSE” if a new transmission is necessary, for example, if the operator searches for historical entries in the history of the message sequence indicator 23.

The transmission status of the individual specializations of the complex control element 22 are ascertained by a monitoring service 26 (corresponding to the monitoring service 10 in FIG. 1) and made available to a visualization service 27. The visualization service 27 corresponds to the visualization service 9a, 9b in FIG. 1 and is implemented on the operator station server 2 for a first part and on the operator station client 3 for a second part. The visualization service 9a, 9b transmits the plant mimic diagram 20 or plant mimic diagrams 20 from the operator station server 2 to the operator station client 3. The transmission contains the diagram element or elements 21 with their transmission status.

An operator service 28 (corresponding to the operator service 11a, 11b) transmits an accumulated transmission status of the diagram elements 20 of the plant mimic diagram 20 to the operator station client 3. The accumulated transmission status was previously ascertained by the monitoring service 26 and transmitted to the visualization service 27 (to the first part implemented on the operator station server). The operator service 28 then retrieves the accumulated transmission status from the visualization service 27 and transmits it to the operator station client 3.

FIG. 3 is an enlarged depiction of the plant mimic diagram 15 in FIG. 1 without any further parts of the control system 1. It can be seen that the diagram elements 16, 17 are marked by an interrupted border as “not fully transmitted/loaded”. In addition, the display intensity of the diagram elements 16, 17 is reduced. The accumulated transmission status 29 is depicted in the bottom right-hand corner as additional information for the operator, which in this case has the value “2” since two diagram elements 16, 17 have not been transmitted fully.

FIG. 4 shows the plant mimic diagram 15 in FIG. 3, where all diagram elements 16, 17 have been fully transmitted to the operator station client 3, which is why the diagram elements 16, 17 are visually displayed in the normal way. The accumulated transmission status 29 is displayed by a (green) rectangle (without a numerical value or with the numerical value “0”) that intuitively indicates to the operator that all diagram elements 16, 17 of the plant mimic diagram 15 have been fully transmitted from the operator station server 2 to the operator station client 3.

Overall, the disclosed embodiments of the invention can contribute to higher reliability and currency of the control system of the technical plant, especially when using a web-based control system.

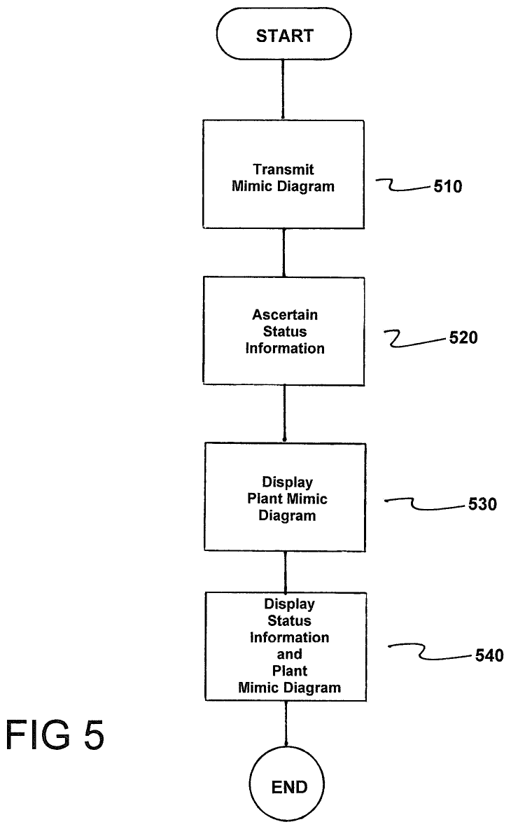

FIG. 5 is a flowchart of the method for visually displaying a mimic diagram 15, 20 of a technical plant by a control system 1 including an operator station server 2 and an operator station client 3, where the plant mimic diagram 15, 20 comprises a plurality of diagram elements 16, 17.

The method comprises a) transmitting a mimic diagram 15, 20 of the technical plant from the operator station server 2 to the operator station client 3, as indicated in step 510. In accordance with the invention, the plant mimic diagram 15, 20 comprises the plurality of diagram elements 16, 17.

Next, b) information about an accumulated transmission status of the plurality of diagram elements 16, 17 from the operator station server 2 to the operator station 3 is ascertained during transmission of the plant mimic diagram 15, 20 with the plurality of diagram elements 16, 1, as indicated in step 520.

Next, c) the plant mimic diagram 15, 20 with the plurality of diagram elements 16, 17 is visually displayed to an operator of the control system 1 by the operator station client 3, as indicated in step 530.

Next, d) the information about the accumulated transmission status of the plurality of diagram elements 16, 17 from the operator station server 2 to the operator station client 3 is visually displayed together with the visual display of the plant mimic diagram 15, 20 with the plurality of diagram elements 16, 17, as indicated in step 540. In accordance with the invention, accumulated transmission status represents a logical Boolean value.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A control system for a technical plant, comprising:
an operator station server; and
an operator station client,
wherein the operator station server is configured to transmit, for operating and observation, a mimic diagram of the technical plant to the operator station client;
wherein the plant mimic diagram comprises a plurality of diagram elements;
wherein the operator station client is configured to visually display the plant mimic diagram with the plurality of diagram elements to an operator of the technical plant;
wherein the control system includes a visualization service which is implemented on the operator station server for a first part and on the operator station client for a second part;
wherein the visualization service is configured to ascertain information about an accumulated transmission status of the plurality of diagram elements from the operator station server to the operator station client and to visually display the ascertained information to the operator of the control system, wherein the accumulated transmission status representing a logical Boolean value.

10. The control system as claimed in claim 9, wherein the accumulated transmission status represents a number of transmission statuses with a specific logical Boolean value, in particular the logical Boolean value FALSE.

11. The control system as claimed in claim 10, wherein the specific logical Boolean value comprises a logical Boolean value of FALSE.

12. The control system as claimed in claim 9, wherein the transmission status of a diagram element is influenceable by interaction between the operator and the diagram element.

13. The control system as claimed in claim 9, wherein the control system is configured to store information in a memory about a period of time over which a diagram element of a plant mimic diagram has had a particular transmission status.

14. The control system as claimed in claim 9, wherein the diagram element includes content which is changeable during runtime of the technical plant.

15. The control system as claimed in claim 14, wherein the content comprises a trend indicator for measured values of the technical plant, a message sequence indicator for messages from the control system, a video image or a regulator optimization function.

16. The control system as claimed in claim 9, wherein the technical plant comprises a process or manufacturing plant.

17. The control system as claimed in claim 9, wherein the control system operates a technical plant comprising a process or manufacturing plant.

18. A method for visually displaying a mimic diagram of a technical plant by a control system including an operator station server and an operator station client, the plant mimic diagram comprising a plurality of diagram elements, the method comprising:
a) transmitting a mimic diagram of the technical plant from the operator station server to the operator station client, the plant mimic diagram comprising the plurality of diagram elements;
b) ascertaining information about an accumulated transmission status of the plurality of diagram elements from the operator station server to the operator station during transmission of the plant mimic diagram with the plurality of diagram elements;
c) visually displaying the plant mimic diagram with the plurality of diagram elements to an operator of the control system by the operator station client; and
d) visually displaying the information about the accumulated transmission status of the plurality of diagram elements from the operator station server to the operator station client together with the visual display of the plant mimic diagram with the plurality of diagram elements, the accumulated transmission status representing a logical Boolean value.

19. The method as claimed in claim 18, wherein the ascertainment of the information about the transmission status of the diagram element is performed by a visualization service; and wherein a first part of the visualization service is implemented on the operator station server and a second part of the visualization service is implemented on the operator station client.

20. The method as claimed in claim 18, wherein the technical plant comprises a process or manufacturing plant.
